(19) United States
(12) Patent Application Publication
(10) Pub. No.: US 2026/0202559 A1
(43) Pub. Date: Jul. 16, 2026

(54) X-RAY IMAGING SYSTEM FOR IMAGING A SAMPLE

(71) Applicant: Carl Zeiss SMT GmbH, Oberkochen (DE)

(72) Inventor: Johannes RUOFF, Cupertino, CA (US)

(21) Appl. No.: 19/015,871

(22) Filed: Jan. 10, 2025

(51) Int. Cl. G01T 1/20; G01T 1/29

(52) U.S. Cl. CPC G01T 1/20185; G01T 1/2002; G01T 1/20188; G01T 1/2985

(57) ABSTRACT

An x-ray imaging system is configured to image a sample arranged in an object plane of the system. The x-ray imaging system comprises an x-ray detector assembly. The x-ray detector assembly comprises: a scintillator element for converting incoming x-rays into detectable light; a non-magnifying fiber optic plate for guiding the detectable light from the scintillator element to a detector unit; and the detector unit which is configured for detecting the detectable light.

### FIELD

The present disclosure relates to an x-ray imaging system for imaging a sample.

### BACKGROUND

X-rays are widely used in microscopy at least in part because of their short wavelengths and ability to penetrate objects. Three-dimensional (3D) x-ray imaging techniques can be useful to image internal structures of objects. Typically, based on a dataset including x-ray transmission images of a sample that are collected over a large angular range, 3D images can be reconstructed. An x-ray imaging system usually comprises a sample mount to support a sample, an x-ray source configured to illuminate a region of interest of the sample, and a position-sensitive x-ray detector configured to record x-rays transmitted through the region of interest of the sample. An x-ray imaging system with a high spatial resolution can be used to resolve small structures of a sample.

### SUMMARY

The present disclosure seeks to provide an improved x-ray imaging system.

According to an aspect, the disclosure provides an x-ray imaging system for imaging a sample arranged in an object plane of the system. The x-ray imaging system comprises an x-ray detector assembly. Further, the x-ray detector assembly includes: a scintillator element for converting incoming x-rays into detectable light; a non-magnifying fiber optic plate for guiding the detectable light from the scintillator element to a detector unit; and the detector unit for detecting the detectable light.

Conventionally, the total magnification of an x-ray imaging system can be split into two parts, namely a geometrical magnification and an optical magnification. The geometrical magnification is usually defined by the geometrical arrangement of an x-ray source, a sample and a detector. Further, the optical magnification is typically provided by magnifying optics used to image the light from a scintillator element (upon which the x-rays are impinging) onto a two-dimensional array of the detector unit.

By using the fiber optic plate (FOP) for guiding the detectable light from the scintillator element to the detector unit of the proposed x-ray detector assembly, an improved and simplified light transfer between the scintillator element and the detector unit can be realized.

For example, using the fiber optic plate can help allow for a more compact configuration of the x-ray detector assembly compared to conventional x-ray detector assemblies. The reason is that, in general, no lenses or mirrors and no focusing distance are used in the x-ray detector assembly - generally in contrast to conventional x-ray detector assemblies using magnifying imaging optics. By using the fiber optic plate, the x-ray detector assembly can be configured with a shorter total length than a conventional x-ray detector assembly (the length being a length with respect to a direction of the light transfer inside the x-ray detector assembly). The installation space for the x-ray detector assembly can be reduced.

Image distortions can be smaller when using a fiber optic plate for light transfer compared to lens-based transfer optics. A fiber optic plate can have a higher light transmission rate than an imaging optic. A fiber optic plate can be configured for absorbing stray light during transmission and, hence, a signal-to-noise ratio (SNR) of the x-ray imaging can be improved.

By using a fiber optic plate for guiding the detectable light from the scintillator element to the detector unit of the proposed x-ray detector assembly, in general, no additional magnification inside the x-ray detector assembly is used because a detector with a small pixel size can be coupled by use of the fiber optic plate to the scintillator element.

The x-ray imaging system can be configured for imaging a region of interest of a sample. The sample is, for example, a flat extended object. The sample is, for example, a wafer. The wafer includes, for example, electronic and/or semiconductor components. Just as an example, the x-ray imaging system may be used to inspect the wafer to investigate the quality of packaging of electronic components of the wafer. For example, the quality of mechanical and electrical bonding (e.g., buried interconnections) of the electronic components may be controlled. However, the sample may also be another object than a wafer. The sample is, for example, a circuit board or a battery.

The x-ray imaging system is, for example, a transmission x-ray imaging system, wherein the x-rays impacting on the region of interest of the sample are partly transmitting through the region of interest and are partly absorbed by the region of interest. The position-dependent transmitted portion of the x-rays is detected by the x-ray detector assembly, for example, as a two-dimensional image.

The x-ray imaging system is, for example, a three-dimensional imaging system. The x-ray imaging system is, for example, configured to obtain two-dimensional transmission images of the region of interest for different rotation angles of the sample. Based on the obtained two-dimensional transmission images, a three-dimensional image of the region of interest can be reconstructed to reveal interior structures of the region of interest. The x-ray imaging system comprises, for example, a control device for reconstructing the three-dimensional images. The x-ray imaging system is, for example, an x-ray three-dimensional imaging system obtaining three-dimensional images by x-ray laminography and/or x-ray tomography.

The sample is, for example, supported on a rotatable sample mount for rotating the sample with respect to a rotation axis of the sample mount such that the region of interest of the sample can be imaged for different rotation angles. The sample mount has, for example, a support surface for supporting the sample. The support surface is, for example, defining the object plane of the x-ray imaging system.

The sample mount may comprise an opening for unhindered passing through of x-rays. With such an opening, an attenuation of x-rays by material of the sample mount can be avoided.

The x-ray detector assembly is, for example, configured for position-sensitive x-ray detection of x-rays transmitted through the region of interest of the sample.

The scintillator element of the x-ray detector assembly can be configured to convert incoming x-rays into light of longer wavelength, e.g., ultraviolet light, visible light or infrared light. This detectable light can be transmitted from the scintillator element to the detector unit.

The detector unit includes, for example, a two-dimensional detector array. The detector unit is, for example, a position-sensitive detector unit. The detector unit is, for example, configured for detecting ultraviolet-, visible and/or infrared light.

The detector unit may include, for example, a CMOS sensor (Complementary Metal-Oxide Semiconductor sensor). For example, the detector unit includes an active pixel sensor (APS) based on CMOS technology (CMOS-APS) and/or a scientific CMOS sensor. The detector unit may alternatively include a CCD sensor (Charged Coupled Device sensor).

The x-ray detector assembly may comprise, for example, an x-ray transmissive entrance window. Further, the scintillator element is, for example, arranged adjacent and/or attached to the entrance window. The entrance window of the x-ray detector assembly (e.g., of a housing of the x-ray detector assembly) includes, for example, an inner surface facing an interior space of the housing. Further, the entrance window includes, for example, an outer surface which is arranged opposite the inner surface. The outer surface of the entrance window can be configured to face the sample during imaging of the sample. The scintillator element is, for example, arranged adjacent and/or attached to the inner surface of the entrance window. The inner and outer surfaces of the entrance window are, for example, arranged parallel to each other.

The entrance window being x-ray transmissive means, for example, that it has an x-ray transmission such that more than 50% of the x-rays irradiating the outer surface of the entrance window and having energies greater than one-half of a selected maximum focused electron energy are transmitted through the entrance window to its inner surface.

A material of the entrance window includes, for example, atomic elements having atomic numbers less than 14. The material of the entrance window includes, for example, one or more of a group including beryllium (Be), diamond, boron carbide (B₄C), silicon carbide (SiC), aluminum (Al), and beryllium oxide (BeO).

Optionally, a shielding element for shielding a first portion of an incoming x-ray beam may be attached to the outer surface of the entrance window, the shielding element comprising an opening for passing through of a second portion of the incoming x-ray beam. The shielding element has, for example, a ring shape. A material of the shielding element includes, for example, tungsten (W), bismuth (Bi), lead (Pb), platinum (Pt), depleted uranium (U) and/or another chemical element with a high atomic number (e.g., above 70).

The scintillator element is, for example, attached to the inner surface of the entrance window of the housing of the x-ray detector assembly by gluing or another suitable manner.

The scintillator element has, for example, an extended rectangular block shape which extends mainly in a main plane of extension. Further, the input face and the output face of the scintillator element are, for example, arranged parallel to the main plane of extension of the scintillator element.

The scintillator element has, for example, a thickness in a direction perpendicular to its main plane of extension of from one micron (μm) to 500 μm (e.g., from 1 μm to 200 μm, from 1 μm to 50 μm, from 1 μm to 30 μm, from 1 μm to 20 μm).

A material of the scintillator element includes, for example, one or more of the group comprising CsI, NaI: Tl, CsI: Tl, CsI: Na, CsI, BaF2, CeF3, BGO, PWO:Y, LSO/LYSO, CsPbBr3 and CsPbI3.

A refractive index of the material of the scintillator element is, for example, between 1.50 and 2.20.

The non-magnifying fiber optic plate is configured for guiding the detectable light from the scintillator element to the detector unit. The fiber optic plate (also called faceplate) comprises, for example, numerous optical fibers, each fiber being configured to guide light from the scintillator element to the detector unit. The fiber optic plate comprises, for example, hundreds, thousands or even millions of coherent optical fibers. The fibers are, for example, fused into a matrix material.

For example, each pixel of the two-dimensional array of the detector unit is coupled to one or more fibers of the fiber optic plate. The fiber optic plate comprises, for example, an input face coupled (e.g., directly) to the scintillator element and an output face coupled (e.g., directly) to the detector unit. The fibers of the fiber optic plate can optically connect numerous input points at the input face to corresponding output points of the output face. The fiber optic plate can provide a one-to-one image transfer from the input face (and hence from the scintillator element) to the output face (and hence to the detector unit).

An outer shape of the fiber optic plate has, for example, an extended rectangular block shape which extends mainly in a main plane of extension. The input face and/or the output face of the fiber optic plate are, for example, arranged parallel to the main plane of extension of the fiber optic plate.

The main plane of extension of the scintillator element, the main plane of extension of the fiber optic plate and/or a main plane of extension of the detector unit (e.g., the plane of extension of a two-dimensional array of the detector unit) are, for example, arranged parallel to each other.

According to some embodiments, the fiber optic plate is a non-tapered fiber optic plate.

Thus, the optical fibers of the fiber optic plate can be straight fibers arranged parallel to each other.

According to some embodiments, the x-ray detector assembly is configured for non-magnified imaging from the scintillator element to the detector unit.

Thus, the x-ray detector assembly can be configured for one-to-one imaging without magnification or demagnification. In other words, a magnification scale (enlargement scale) of the x-ray detector assembly can be 1:1, and a magnification factor of the x-ray detector assembly can be one.

According to some embodiments, a pixel size of the detector unit is 15 μm or less (e.g., 10 μm or smaller, 5 μm or less, 3 μm or less, 2 μm or less, 1 μm or less).

The pixel size of the detector unit is, for example, less than 2 μm.

Having a small pixel size of the detector unit, a moderate total magnification of the x-ray imaging system (e.g., a magnification factor between 30 and 150) can be sufficient to perform high-resolution x-ray imaging. This moderate total magnification of the x-ray imaging system can, for example, be achieved solely by the geometric magnification of the system without using a post-magnification of the x-ray detector assembly.

By having the small pixel size of the detector unit, x-ray imaging with a relatively high spatial resolution can be possible without applying a very large geometric magnification (e.g., a magnification factor of 500 or more). This can be desirable compared to a configuration where a conventional flat panel detector (FPD) is used with pixel sizes in the range of 50 μm to 100 μm (e.g., 75 μm), and where a relatively large geometric magnification is typically used. A relatively large geometric magnification usually involves a relatively large distance (e.g., one meter or more) between the x-ray detector assembly and the sample. With such a large detector assembly-sample distance, the footprint of the x-ray imaging system would typically be very large (e.g., several meters). However, with the proposed small pixel size of the detector unit, x-ray imaging with high spatial resolution (e.g., 100 nm resolution) can be possible with an only moderate total magnification of the x-ray imaging system (e.g., a magnification factor between 50 and 100) and a moderate detector assembly-sample distance (e.g., well below one meter, such as 25 centimeters (cm)).

According to some embodiments, the detector unit comprises a scientific CMOS sensor.

A scientific CMOS sensor (sCMOS sensor) can offer a lower noise, a higher frame rate, a larger dynamic range, and/or a higher quantum efficiency compared to a conventional CMOS sensor.

According to some embodiments, an x-ray propagation axis of the x-ray imaging system is inclined relative to the object plane by a first angle. Furthermore, a surface normal of a main plane of extension of the scintillator element of the x-ray detector assembly can be inclined relative to the x-ray propagation axis and away from the object plane by a second angle. The second angle can have a value of 10° or more (e.g., 12° or more, 15° or more, 20° or more, 30° or more).

The surface normal of the main plane of extension of the scintillator element is not arranged parallel to the x-ray propagation axis but inclined by the second angle. In other words, the main plane of extension of the scintillator element is not arranged perpendicular (i.e. at a right angle of 90°) relative to the x-ray propagation axis but at an oblique angle deviating from a right angle by the second angle.

By the tilt of the surface normal of the scintillator element relative to the x-ray propagation axis, the x-ray detector assembly can be arranged closer to the sample mount and the sample without risking a collision of the x-ray detector assembly with the sample. The x-ray imaging system can be configured more compact and with a smaller footprint.

Because an oblique irradiation of the scintillator element with x-rays under the second angle can lead to a loss in spatial resolution, the choice of the value of the second angle can be a tradeoff between a compact configuration of the system for a large second angle and a better spatial resolution for a small second angle. The applicant has found that—in comparison to a perpendicular irradiation of the scintillator element (i.e., the second angle being zero)—the loss in spatial resolution for an oblique irradiation of the scintillator element (i.e., the second angle being larger than zero) can be neglectable and/or very small when choosing a value for the second angle of 20° at maximum. The applicant has found that the loss in spatial resolution can be limited to about a factor of 1.4 or less when choosing a value for the second angle of 30° at maximum, and can be limited to about a factor of two or less when choosing a value for the second angle of 40° at maximum.

Therefore, the second angle has, for example, a value of from 10° to 20°, from 12° to 20°, from 12° to 30°, and/or from 12° to 40°.

The loss in spatial resolution due to the oblique irradiation of the scintillator element is generally proportional to a thickness of the scintillator element in a direction perpendicular to its main plane of extension. Hence, a small thickness of the scintillator element (e.g., 30 μm or smaller, 20 μm or smaller, 10 μm or smaller and/or 5 μm or smaller) can be desirable in such embodiments.

The x-ray propagation axis can extend from an x-ray source of the x-ray imaging system (i.e., a source region of the x-ray source), through the region of interest of the sample, and to the x-ray detector assembly. The x-ray source can generate diverging x-rays, i.e. a cone (conus) of x-rays. A portion (i.e. a sub cone) of the generated diverging x-rays can irradiate the region of interest of the sample. A center line of this sub cone of x-rays is referred herein as x-ray propagation axis. This means that the x-ray propagation axis indicates the direction of an x-ray beam which is a portion of the total generated diverging x-rays of the x-ray source.

The scintillator element has, for example, an extended rectangular block shape which extends mainly in the main plane of extension. Further, the input face and the output face of the scintillator element are, for example, arranged parallel to the main plane of extension of the scintillator element.

The main plane of extension of the scintillator element, a main plane of extension of the fiber optic plate and/or a main plane of extension of the detector unit (e.g., the plane of extension of a two-dimensional pixel array of the detector unit) are, for example, arranged parallel to each other. In this case, also a surface normal of the main plane of extension of the fiber optic plate and/or the detector unit is/are arranged inclined relative to the x-ray propagation axis by the second angle.

The first angle has, for example, a value of 10° or more (e.g., 12° or more, 15° or more, 20° or more and/or 30° or more).

According to some embodiments, the second angle has a value in the range of 12° as a lower limit and 90° minus the first angle as an upper limit.

The upper limit of the second angle being in the range of 90° minus the first angle means that a sum of the first angle and the second angle is 90° or smaller.

According to some embodiments, the x-ray imaging system comprises an x-ray source for emitting x-rays towards a region of interest of the sample, wherein the x-ray detector assembly is configured for detecting x-rays transmitted through the region of interest.

The x-ray source comprises, for example, a vacuum chamber. Further, the x-ray source comprises, for example, a pump for evacuating the vacuum chamber. The x-ray source further comprises, for example, an electron source accommodated in the vacuum chamber. The electron source can be configured for emitting an electron beam towards an x-ray target of the x-ray source. The electron source includes, for example, a cathode and an anode and the like for generating electrons and for accelerating the generated electrons. The x-ray source further comprises, for example, one or more electron optics units for directing, deflecting and/or shaping the electron beam emitted from the electron source. The electron optics include, for example, one or more magnetic lenses for focusing the electron beam and/or one or more deflection units for deflecting the electron beam.

The x-ray source further comprises, for example, an x-ray target. The x-ray target can be configured for emitting x-rays when bombarded with the focused electron beam. A material of the at least one x-ray target comprises, for example, one or more of a group including tungsten (W), copper (Cu), chromium (Cr), molybdenum (Mo), rhodium (Rh) and platinum (Pt). The x-rays generated by the at least one x-ray target can include characteristic lines determined by the target's composition and broad bremsstrahlung radiation.

The x-ray source includes, for example, a carrier element carrying the x-ray target (or carrying multiple of the x-ray targets which can be selected by directing the electron beam accordingly). The carrier element is, for example, x-ray transmissive. The carrier element forms, for example, a vacuum window of the vacuum chamber. Alternatively, an additional vacuum window may be provided. A material of the carrier element and/or the vacuum window includes, for example, atomic elements having atomic numbers less than 14. The material of the carrier element and/or the vacuum window includes, for example, one or more of a group including beryllium (Be), diamond, boron carbide (B₄C), silicon carbide (SiC), aluminum (Al), and beryllium oxide (BeO). The material of the carrier element and/or the vacuum window can be diamond.

The carrier element and/or the vacuum window being x-ray transmissive means, for example, that it has an x-ray transmission such that more than 50% of the x-rays generated by the at least one x-ray target having energies greater than one-half of the selected maximum focused electron energy are transmitted through the carrier element.

The carrier element has, for example, a sufficiently high thermal conductivity to provide a thermal conduit to prevent thermal damage (e.g., melting) of the x-ray target. Further, the carrier element can, for example, also provide an electrically conductive path to dissipate electric charge from the at least one x-ray target and/or the carrier element itself.

The x-ray source is, for example, a transmission target type x-ray source. The electron beam can strikes the at least one x-ray target of the x-ray source at its backside, the at least one x-ray target can emit x-rays at its front side, and the emitted x-rays can be used to irradiate the sample.

According to some embodiments, a geometric magnification of the x-ray imaging system is equal to a ratio of a first distance and a second distance, the first distance being a distance between the x-ray source and the x-ray detector assembly, and the second distance being a distance between the x-ray source and the region of interest of the sample. In addition, the geometric magnification of the x-ray imaging system can be 100 or less (e.g., 75 or less, 50 or less, 30 or less, 10 or less).

With a moderate geometric magnification of the x-ray imaging system of 100 or less (e.g., 75 or less, 50 or less, 30 or less), a geometric size of the x-ray imaging system, e.g., a footprint of the x-ray imaging system can be configured relatively small (e.g., well below one meter). Hence, an installation space of the x-ray imaging system can be reduced.

The first distance is, for example, a distance between a source spot of the x-ray source and an entrance window and/or the scintillator element of the x-ray detector assembly. Further, the second distance is, for example, a distance between the source spot of the x-ray source and the region of interest (e.g., a geometrical center and/or center of mass of the region of interest) of the sample.

According to a further embodiment, a distance between the x-ray source and the x-ray detector assembly is 1000 millimeters (mm) or less (e.g., 500 mm or less, 300 mm or less, 100 mm or less).

A compact x-ray imaging system can be provided.

According to some embodiments, the x-ray imaging system comprises a sample mount for supporting the sample rotatably around a rotation axis, wherein the x-ray imaging system is configured for obtaining two-dimensional transmission images of the region of interest of the sample for different rotation angles of the sample with respect to the rotation axis, and for reconstructing a three-dimensional image of the region of interest based on the two-dimensional transmission images.

The x-ray imaging system comprises, for example, a control device for reconstructing the three-dimensional images.

For example, the x-ray imaging system is configured for obtaining two-dimensional transmission images of the region of interest of the sample for different rotation angles of the sample with respect to the rotation axis, wherein the rotation angles span a large angular range of, for example, 180° or more (e.g., 270° or more, 360°).

Further possible implementations or alternative solutions of the disclosure also encompass combinations—that are not explicitly mentioned herein—of features described above or below with regard to the embodiments. The person skilled in the art may also add individual or isolated aspects and features to the most basic form of the disclosure.

### BRIEF DESCRIPTION OF THE DRAWINGS

Further embodiments, features and aspects of the present disclosure will become apparent from the subsequent description and dependent claims, taken in conjunction with the accompanying drawings, in which:

FIG. 1 shows a schematic view of an x-ray imaging system for imaging a sample;

FIG. 2 shows a schematic view of an x-ray imaging system for imaging a sample;

FIG. 3 shows a front view of a detector unit of an x-ray detector assembly of the x-ray imaging system of FIG. 2;

FIG. 4 shows a detailed view of an x-ray detector assembly of the x-ray imaging system of FIG. 2;

FIG. 5 shows a schematic view of an x-ray imaging system for imaging a sample; and

FIG. 6 shows a detailed view of an x-ray detector assembly of the x-ray imaging system of FIG. 5.

### DETAILED DESCRIPTION

In the Figures, like reference numerals designate like or functionally equivalent elements, unless otherwise indicated.

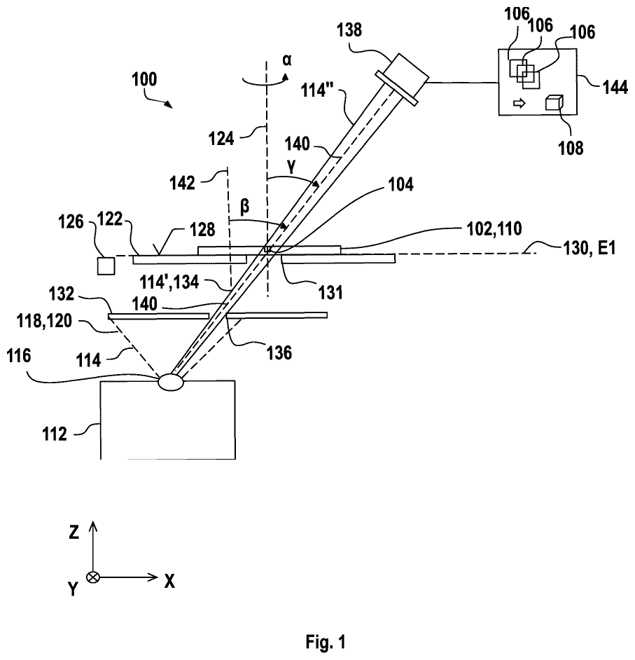

FIG. 1 shows a schematic view of an x-ray imaging system 100 according to an embodiment. The x-ray imaging system 100 is used for imaging a sample 102, for example a region of interest 104 of the sample 102. The x-ray imaging system 100 is configured to obtain two-dimensional transmission images 106 of the region of interest 104 for different rotation angles α of the sample 102. Based on the two-dimensional transmission images 106, a three-dimensional (3D) image 108 of the region of interest 104 is reconstructed to reveal interior structures of the region of interest 104. The x-ray imaging system 100 is, hence, an x-ray 3D imaging system obtaining 3D images 108 by x-ray laminography and/or x-ray tomography. The sample 102 is, for example, a flat object extended in a main plane E1 (first plane E1), e.g., the xy-plane in FIG. 1. The sample 102 is, for example, a wafer 110 comprising electronic and/or semiconductor components. Just as an example, the x-ray imaging system 100 may be used to inspect the wafer 110 to investigate the quality of packaging of electronic components of the wafer 110. For example, the quality of mechanical and electrical bonding (e.g., buried interconnections) of the electronic components may be controlled.

The x-ray imaging system 100 comprises an x-ray source 112 for emitting x-rays 114. The x-rays 114 are emitted from a source region 116 of the x-ray source 112. The x-ray source 112 emits a diverging beam 118 of x-rays 114. In other words, the x-ray source 112 emits a cone 120 of x-rays 114. The sample 102 is arranged within the x-ray emission cone 120.

The x-ray imaging system 100 further comprises a rotatable sample mount 122 for supporting the sample 102 and rotating the sample 102 around a rotation axis 124. The rotation axis 124 passes, for example, through the region of interest 104 of the sample 102. For example, the rotation axis 124 can be arranged off-center with respect to a center of the sample 102. A rotation drive 126 for rotating the sample mount 122 and, hence, the sample 102, is shown schematically in FIG. 1. Furthermore, the sample mount 122 has a support surface 128 for supporting the sample 102, wherein the support surface 128 defines an object plane 130 of the x-ray imaging system 100.

The sample mount 122 may comprise an opening 131 for passing through of x-rays. The x-ray imaging system 100 may further optionally comprise, for example, a shield stop 132 arranged between the x-ray source 112 and the sample mount 122. The shield stop 132 is, for example, arranged in a light path of the x-rays 114 emitted from the x-ray source 112. The shield stop 132 serves to select a usable portion 134 (sub cone 134) of the x-ray cone 120. Moreover, the shield stop 132 protects uninspected regions of the sample 102 from x-ray exposure. The shield stop 132 has an aperture 136 through which the usable portion 134 of the x-ray light 114 (114′) propagates in the direction of the region of interest 104 of the sample 102 and transmits through the region of interest 104 of the sample 102.

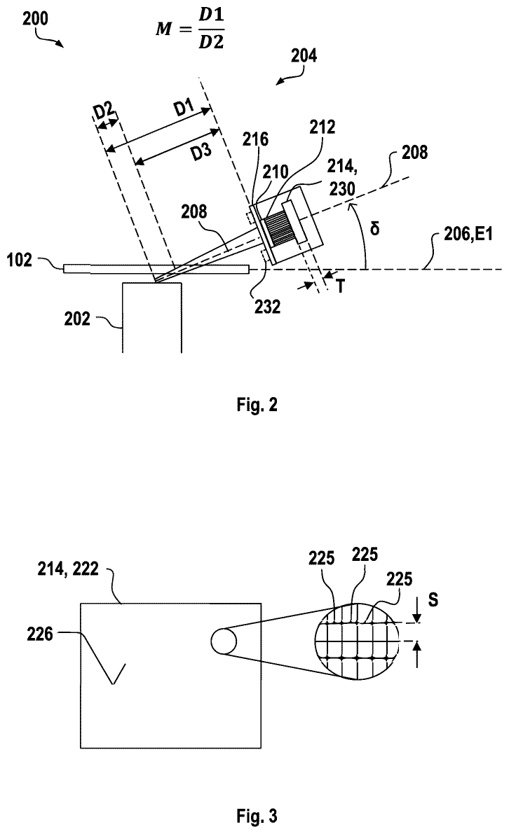

The x-ray imaging system 100 further comprises a position-sensitive x-ray detector assembly 138 for detecting x-rays 114″ transmitted through the region of interest 104 of the sample 102. The x-ray detector assembly 138 is, for example, configured to convert the incoming x-rays 114″ into light of longer wavelength, e.g., ultraviolet light, visible light or infrared light. The x-ray detector assembly 138 includes, for example, a scintillator element 210 (FIG. 2) at an entrance window 216 of the detector assembly 138 for converting the incoming x-rays 114″ into detectable light. The x-ray detector assembly 138 further includes a detector unit 214 (FIG. 2) for detecting the detectable light.

FIG. 1 displays an x-ray propagation axis 140 of the x-ray imaging system 100. For example, a central axis of the portion 134 (sub light cone 134) of the x-ray light 114 passing through the shield stop 132 defines the x-ray propagation axis 140. The x-ray propagation axis 140 extends from the x-ray source 112 (i.e., the source region 116 of the x-ray source 112), through the region of interest 104 of the sample 102, and to the x-ray detector assembly 138.

As can be seen in FIG. 1, the x-ray propagation axis 140 of the x-ray imaging system 100 is, for example, inclined with respect to a surface normal 142 of the sample mount 122 by an angle β. In addition, the x-ray propagation axis 140 is, for example, inclined with respect to the rotation axis 124 by a further angle γ. In the example of FIG. 1, the surface normal 142 of the sample mount 122 and the rotation axis 124 are arranged parallel to each other and, hence, the angle β and the further angle γ have the same size.

The x-ray exposures 106 obtained at different rotation angles α of the sample 102 are reconstructed to a 3D image 108 by a control system 144 of the imaging system 100.

The x-ray imaging system 100 provides microscopic imaging. A magnification and, hence, a spatial resolution, of the x-ray imaging system 100 depends on the geometric magnification of the system 100. As illustrated in FIG. 2, the geometric magnification M of the system 100, 200 is given by a ratio of a first distance D1 between the x-ray source 112, 202 and the x-ray detector assembly 138, 204 and a second distance D2 between the x-ray source 112, 202 and the region of interest 104 of the sample 102. For example, the first distance D1 has a value of 1000 mm or smaller, 500 mm or smaller, 300 mm or smaller and/or 100 mm or smaller. Further, the second distance D2 has, for example, a value of 10 mm or smaller, 5 mm or smaller, 3 mm or smaller and/or 1 mm or smaller.

A third distance D3 between the region of interest 104 of the sample 102 and the x-ray detector assembly 138, 204 is denoted with the reference sign D3 in FIG. 2.

The geometric magnification M of any herein described x-ray imaging system 100, 200, 300 is, for example, 100 or smaller, 75 or smaller, 50 or smaller and/or 30 or smaller. By having such a moderate geometric magnification M, the first and third distances D1, D3 can be configured relatively small. Hence, a small size and compact configuration of the respective x-ray imaging system 100, 200, 300 can be achieved.

Moreover, an imaging time to obtain a 3D image 108 of the region of interest 104 of the sample 102 depends on the x-ray flux density at the region of interest 104. The imaging time (exposure time) limits, for example, a throughput rate when imaging multiple samples 102 with the x-ray imaging system 100. The smaller the second distance D2 between the x-ray source 112 (for example an x-ray target of the x-ray source 112) and the region of interest 104 of the sample 102, the higher is the x-ray flux density at the region of interest 104 of the sample 102. For example, the x-ray flux incident on the region of interest 104 is inversely proportional to the square of the second distance D2.

FIG. 2 shows an x-ray imaging system 200 according to a further embodiment. The x-ray imaging system 200 comprises an x-ray source 202, similar as the x-ray source 112 in FIG. 1. The x-ray imaging system 200 further comprises an x-ray detector assembly 204, similar as the x-ray detector assembly 138 in FIG. 1.

Further, a sample 102 is shown in FIG. 2. A sample mount is not shown in FIG. 2 but can be configured similarly as the sample mount 122 in FIG. 1. The sample 102 is arranged in an object plane 206 similar to the object plane 130 in FIG. 1. The reference sign 208 denotes an x-ray propagation axis of the x-ray imaging system 200 similar as the x-ray propagation axis 140 in FIG. 1. The x-ray propagation axis 208 is inclined relative to the object plane 206 by a first angle δ.

The x-ray detector assembly 204 in FIG. 2 comprises a scintillator element 210 for converting incoming x-rays 114″ into detectable light. The x-ray detector assembly 204 further comprises a fiber optic plate 212 for guiding the detectable light from the scintillator element 210 to a detector unit 214 of the x-ray detector assembly 204. The fiber optic plate 212 is, for example, a non-magnifying fiber optic plate 212. The fiber optic plate 212 is, for example, a non-tapered fiber optic plate. The fiber optic plate 212 transmits the detectable light from the scintillator element 210 one-to-one to the detector unit 214.

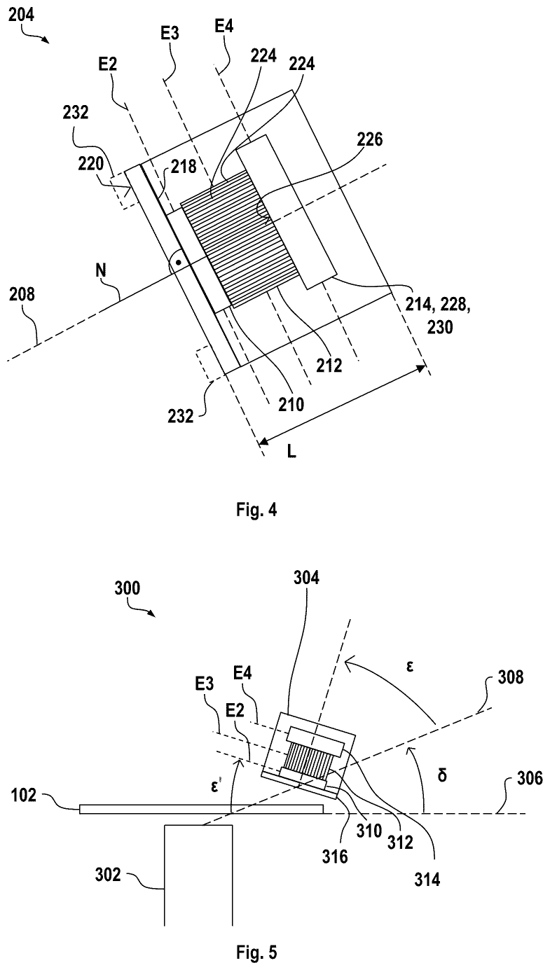

By using the fiber optic plate 212 for guiding the detectable light from the scintillator element 210 to the detector unit 214, a light transfer between the scintillator element 210 and the detector unit 214 can be improved and simplified. For example, imaging optics including lenses or mirrors can be omitted in the x-ray detector assembly 204. Further, with the fiber optic plate 212 a very compact configuration of the x-ray detector assembly 204 is possible because, in general, no lenses or mirrors and no focusing distance are used. Hence, using the fiber optic plate 212, the x-ray detector assembly 204 can be configured with a very short total length L (FIG. 4). In addition, the fiber optic plate 212 provides smaller image distortions, a higher light transmission rate and a higher signal-to-noise ratio compared to imaging optics.

Using the fiber optic plate 212 for guiding the detectable light from the scintillator element 210 to the detector unit 214 means that typically no additional magnification inside the x-ray detector assembly 204 is used because a detector unit 214 with a small pixel size S (FIG. 3) can be used.

The x-ray detector assembly 204 is, for example, configured for non-magnified imaging from the scintillator element 210 to the detector unit 214. Hence, a total magnification of the x-ray imaging system 200 is set by a geometric magnification M of the x-ray imaging system 200, the geometric magnification M being defined as the ratio of the first distance D1 to the second distance D2.

The x-ray detector assembly 204 further comprises, for example, an x-ray transmissive entrance window 216. The scintillator element 210 is, for example, attached to an inner surface 218 (FIG. 4) of the entrance window 216, the inner surface 218 being arranged opposite an outer surface 220 of the entrance window 216.

As illustrated in FIG. 4, the fiber optic plate 212 includes numerous fibers 224 (some of them are shown in FIG. 4 and two of them have been denoted with a reference sign in FIG. 4). The detector unit 214 is configured for detecting the detectable light generated by the scintillator element 210 and transmitted from the scintillator element 210 by the fibers 224 of the fiber optic plate 212 to the detecting surface 226 of the detector unit 214.

As shown in FIG. 3, the detector unit 214 includes at its detecting surface 226 a two-dimensional array 222 of pixels 225. Some of the pixels 225 are denoted in the enlarged inset of FIG. 3 with a reference sign. A pixel size S of the detector unit 214 is, for example, 15 μm or smaller, 10 μm or smaller, 5 μm or smaller, 3 μm or smaller, 2 μm or smaller and/or 1 μm or smaller.

### The detector unit 214 comprises, for example, a CMOS sensor 228 and/or a scientific CMOS sensor 230.

As shown with dashed lines in FIG. 4, the x-ray detector assembly 204 may optionally comprise a shielding element 232 for shielding a portion of the incoming x-rays 114″.

As illustrated in FIG. 4, the scintillator element 210 has, for example, an extended rectangular block shape with a main plane E2 of extension (second plane E2). Further, also the fiber optic plate 212 has, for example, an extended rectangular block shape with a main plane E3 of extension (third plane E3). Moreover, also the detector unit 214 has a main plane E3 of extension (fourth plane) defined by its two-dimensional pixel array. The main planes E2, E3, E4 of extensions of the scintillator element 210, the fiber optic plate 212 and the detector unit 214 are, for example, arranged parallel to each other, as shown in FIGS. 2 and 4.

In the embodiment of FIGS. 2 and 4, a surface normal N of the main plane E2 of extension of the scintillator element 210 of the x-ray detector assembly 204 is arranged parallel to the x-ray propagation axis 208 of the system 200. In other words, the x-ray propagation axis 208 is arranged perpendicular to the main plane E2 of extension of the scintillator element 210.

In FIG. 5, an x-ray imaging system 300 according to a further embodiment is shown. The x-ray imaging system 300 comprises, similar as the x-ray imaging system 200 in FIGS. 2, 4 an x-ray source 302, a sample mount (not shown) for supporting a sample 102 and an x-ray detector assembly 304. Further, an x-ray propagation axis 308 of the x-ray imaging system 300 in FIG. 5 is, similar as the x-ray propagation axis 208 of the system 200 in FIGS. 2, 4, inclined relative to an object plane 306 of the system 300 by a first angle δ. Moreover, the x-ray detector assembly 304 in FIG. 5 comprises, similar as the x-ray detector assembly 204 in FIGS. 2, 4, an optional entrance window 316, a scintillator element 310, a non-magnifying fiber optic plate 312 and a detector unit 314.

The x-ray imaging system 300 of FIG. 5 differs from the x-ray imaging system 200 of FIGS. 2, 4 by a different orientation of the x-ray detector assembly 304 with respect to the x-ray propagation axis 308. For example, the x-ray detector assembly 304 in FIG. 5 is orientated with respect to the x-ray propagation axis 308 such that a surface normal N of a main plane E2 of extension of the scintillator element 310 is inclined relative to the x-ray propagation axis 308 by a second angle ε. As shown in FIG. 5, the surface normal N of the main plane E2 of extension of the scintillator element 310 is inclined relative to the x-ray propagation axis 308 and away from the object plane 306. The second angle ε has, for example, a value of more than 10°, 12° or more, 15° or more, 20° or more and/or 30° or more.

In addition or instead, the second angle ε has, for example, a value in the range of 12° as a lower limit and 90° minus the first angle δ as an upper limit. This means that a sum of the first angle δ and the second angle ε is 90° or smaller.

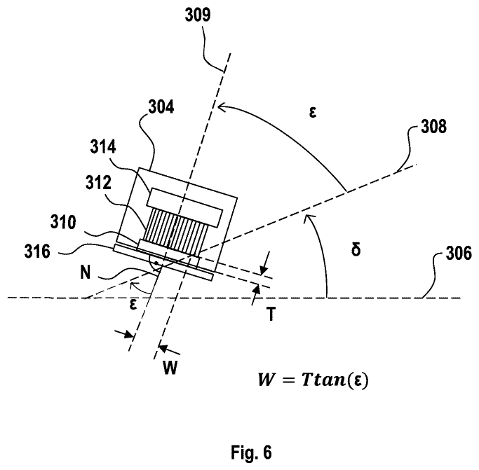

By the tilt of the surface normal N of the scintillator element 210 relative to the x-ray propagation axis 308, the x-ray detector assembly 304 can be arranged closer to the sample 102 (smaller distances D1, D3, see FIG. 2) without risking a collision of the x-ray detector assembly 304 with the sample 102. Hence, an even more compact x-ray imaging system 300 can be provided. The oblique irradiation of the scintillator element 210 with x-rays 114″ under the angle ε shown in FIG. 5 (instead of under an angle of 90° as shown in FIGS. 1, 2) can lead to a loss in spatial resolution of the x-ray imaging system 300. As shown in FIG. 6, the scintillator element 310 has a thickness T in a direction perpendicular to its main plane E2 of extension. When an x-ray 114″ travels along an oblique beam path (angle ε) through the scintillator element 310, scintillator photons (“detectable light”) will be emitted along the whole beam path in the direction of the fiber optic plate 312. Hence, a single x-ray 114″ will emit detectable light in an extended region with width W. The width W is, for example, a width parallel to the main plane E2 of extension of the scintillator element 310. Further, the width W depends on the thickness T of the scintillator element 310 and the angle ε of oblique irradiation as described by the equation: W=T tan(ε).

Since an oblique irradiation of the scintillator element 310 with x-rays 114″ under the angle ε can lead to a loss in spatial resolution, the choice of the second angle ε can be a tradeoff between a compact configuration of the system 300 for a large angle ε and a better spatial resolution for a small angle ε.

The applicant has found that—in comparison to a perpendicular irradiation of the scintillator element 310 (i.e. ε=0, FIG. 2)—the loss in spatial resolution for an oblique irradiation of the scintillator element 310 (i.e. ε >0, FIG. 5) can be neglectable and/or very small for an angle ε of 20° or smaller. This is based, for example, on assuming a thickness T of the scintillator element 310 of 10 μm and a pixel size S of the detector unit 314 of 4 μm. However, also other values can be applied for the thickness T and the pixel size S. Further, the applicant has found that for the given values of T and S the loss in spatial resolution for an oblique irradiation of the scintillator element 310 with an angle ε of 30° can be about a factor of 1.4 and for an angle ε of 40° about a factor of two. The loss in spatial resolution for an oblique irradiation of the scintillator element 310 (i) can be neglectable and/or very small when choosing a value for the second angle ε of up to 20°, (ii) can be limited to, for example, about a factor of 1.4 at maximum when choosing a value for the second angle ε of 30° or below, and (iii) can be limited to, for example, about a factor of two at maximum when choosing a value for the second angle ε of 40° or below.

Although the present disclosure has been described in accordance with certain embodiments, it is obvious for the person skilled in the art that modifications are possible in all embodiments.

### REFERENCE NUMERALS

100 System
102 Sample
104 Region of interest
106 2D image
108 3D image
110 Wafer
112 Source
114 X-ray
114′, 114″ X-ray
116 Source region
118 Beam
120 Cone
122 Sample mount
124 Rotation axis
126 Rotation drive
128 Surface
130 Object plane
131 Opening
132 Shield stop
134 Sub cone
136 Aperture
138 Detector assembly
140 Axis
142 Surface normal
144 Control system
200 System
202 Source
204 Detector assembly
206 Object plane
208 Axis
210 Scintillator element
212 Fiber optic plate
214 Detector unit
216 Window
218 Surface
220 Surface
222 Array
224 Fiber
225 Pixel
226 Surface
228 Sensor
230 Sensor
232 Shielding element
300 System
302 Source
304 Detector assembly
306 Object plane
308 Axis
310 Scintillator element
312 Fiber optic plate
314 Detector unit
316 Window
α Angle
β Angle
γ Angle
δ Angle
ε, ε′ Angle
D1-D3 Distance
E1-E4 Plane
L Length
M Magnification
N Surface normal
S Size
T Thickness
W Width
x,y,z Direction

What is claimed is:

1. An x-ray imaging system, comprising:
an x-ray detector, comprising:
a scintillator element;
a detector unit; and
a non-magnifying fiber optic plate,
wherein:
the scintillator element is configured to convert incoming x-rays into detectable light;
the detector unit is configured to guide the detectable light from the scintillator element to the detector unit; and
the detector unit is configured to detect the detectable light.

2. The x-ray imaging system of claim 1, wherein the fiber optic plate comprises a non-tapered fiber optic plate.

3. The x-ray imaging system of claim 1, wherein the x-ray detector assembly is configured for non-magnified imaging from the scintillator element to the detector unit.

4. The x-ray imaging system of claim 3, wherein the fiber optic plate comprises a non-tapered fiber optic plate.

5. The x-ray imaging system of claim 1, wherein a pixel size of the detector unit is 15 microns or less.

6. The x-ray imaging system of claim 5, wherein the fiber optic plate comprises a non-tapered fiber optic plate.

7. The x-ray imaging system of claim 1, wherein the detector unit comprises a CMOS sensor.

8. The x-ray imaging system of claim 7, wherein the fiber optic plate comprises a non-tapered fiber optic plate.

9. The x-ray imaging system of claim 1, wherein the detector unit comprises a scientific CMOS sensor.

10. The x-ray imaging system of claim 9, wherein the fiber optic plate comprises a non-tapered fiber optic plate.

11. The x-ray imaging system of claim 1, wherein:
an x-ray propagation axis of the x-ray imaging system is inclined by a first angle relative to an object plane of the x-ray imaging system;
a surface normal of a main plane of extension of the scintillator element is inclined relative to the x-ray propagation axis and away from the object plane by a second angle; and
the second angle is 10° or more.

12. The x-ray imaging system of claim 11, wherein the fiber optic plate comprises a non-tapered fiber optic plate.

13. The x-ray system according to claim 11, wherein:
the second angle is at least 12°; and
the second angle is 90° minus the first angle.

14. The x-ray imaging system of claim 1, further comprising an x-ray source configured to emit x-rays toward a region of interest a sample in an object plane of the x-ray imaging system, wherein the x-ray detector assembly is configured to detect x-rays transmitted through the region of interest of the sample.

15. The x-ray imaging system of claim 14, wherein the fiber optic plate comprises a non-tapered fiber optic plate.

16. The x-ray imaging system of claim 14, wherein:
a first distance is a distance between the x-ray source and the x-ray detector assembly;
a second distance is a distance between the x-ray source and the region of interest of the sample;
a geometric magnification of the x-ray imaging system is equal to a ratio of the first distance to the second distance; and
the geometric magnification is 100 or less.

17. The x-ray imaging system of claim 14, wherein a distance between the x-ray source and the x-ray detector assembly is 1000 mm or less.

18. The x-ray imaging system of claim 1, further comprising a mount configured to support a sample in an object plane of the x-ray imaging system so that the sample is rotatable around an axis,
wherein:
the x-ray imaging system is configured to obtain two-dimensional transmission images of a region of interest of the sample for different rotation angles of the sample with respect to the; and
the x-ray imaging system is configured to reconstruct a three-dimensional image of the region of interest of the sample based on the two-dimensional transmission images.

19. The x-ray imaging system of claim 18, wherein the fiber optic plate comprises a non-tapered fiber optic plate.

20. The x-ray imaging system of claim 1, wherein:
the x-ray detector assembly is configured for non-magnified imaging from the scintillator element to the detector unit;
the fiber optic plate comprises a non-tapered fiber optic plate; and
a pixel size of the detector unit is 15 microns or less.
